(19) United States
(12) Patent Application Publication
(10) Pub. No.: US 2007/0214720 A1
(43) Pub. Date: Sep. 20, 2007

(54) Low pressure liquid fuel gasification device and method

(75) Inventor: Chia-Chen Wen, Xizhi City (TW)

Correspondence Address: BRUCE H. TROXELL, SUITE 1404, 5205 LEESBURG PIKE, FALLS CHURCH, VA, 22041, US

(73) Assignee: NonGas Petrochemical Inc.

(21) Appl. No.: 11/416,234

(22) Filed: May 3, 2006

(30) Foreign Application Priority Data
Mar. 17, 2006 (TW) 095109116

(51) Int. Cl. C10J 3/46; C10J 1/20; F02M 17/22

(52) U.S. Cl. 48/197 R; 123/522; 48/199 R

(57) ABSTRACT

A low pressure liquid fuel gasification device and method is disclosed. The device includes a low frequency vibration device for generating low frequency vibration wave to supply vibration energy to compressed air. The contact between the compressed air and organic or inorganic oil liquid fuel with a dry point between 50° C. and 90° C. such as mixed hexane disposed in a fuel container enables the molecule of the oil liquid fuel to vibrate for generating gasified molecule containing the molecule of the oil liquid fuel. The gasified molecule is transported through a gas pipe device to a gas outlet whereby the gasified molecule is ignited for use.

### FIELD OF THE INVENTION

The present invention relates to a low pressure liquid fuel gasification device and method, and particularly to a low pressure liquid fuel gasification device which includes a low frequency vibration device for generating low frequency vibration wave to supply vibration energy to compressed air, whereby the contact between the compressed air and organic or inorganic oil liquid fuel enables the molecule of the oil liquid fuel to vibrate for generating gasified molecule containing the molecule of the oil liquid fuel for burning.

### BACKGROUND OF THE INVENTION

To be filled with more fuel, a conventional fuel container utilizes a manner of high pressure liquefaction. Ignitable gaseous fuel (such as gas, inclusion being composed of propane and butane) is filled in a steel cylinder under a high pressure thereby liquefying the gaseous fuel. In use, a micro quantity of liquefied gaseous fuel is released. Due to great pressure difference between the atmosphere and the interior of the steel cylinder, the volume of the high pressure liquefied fuel is quickly expanded at an extremely quick speed and then the liquefied gaseous fuel is gasified and is released from a valve outlet specially designed to bear a high pressure whereby the gaseous fuel is ignited. for use. The high pressure storage container is generally made of steel. When the filling pressure is higher, the steel cylinder is thicker. However, it is very inconvenient to carry a steel cylinder with an increased thickness.

Furthermore, the conventional fuel storage manner results in high pressure inside the steel cylinder. When the body or an external valve of the steel cylinder is damaged, it is extremely easy to leak the internal high pressure fuel, and when the body is impacted unintendedly by external force, it is extremely easy to explode, which easily causes great damage to people and property.

Therefore, the conventional liquid fuel filling container and use manner have some shortcomings and should be improved.

### SUMMARY OF THE INVENTION

An object of the present invention is to provide a low pressure liquid fuel gasification device which utilizes a low frequency vibration device for generating low frequency vibration wave to supply vibration energy to compressed air, thereby enabling the molecule of organic or inorganic oil liquid fuel to vibrate for generating gasified molecule containing the molecule of the oil liquid fuel for burning.

Another object of the present invention is to provide a low pressure liquid fuel gasification method which utilizes organic or inorganic oil with a dry point between 50° C. and 90° C. as fuel, whereby the activity is very stable at the normal temperature and under the normal pressure and exhaust gas is greatly reduced during burning thereby increasing use security.

Other objects, advantages and novel features of the present invention will be drawn from the following detailed embodiment of the present invention with attached drawings, in which:

### BRIEF DESCRIPTION OF THE DRAWINGS

FIG. 1 is a structure diagram of a low pressure liquid fuel gasification device of the present invention.

### DESCRIPTION OF THE PREFERRED EMBODIMENT

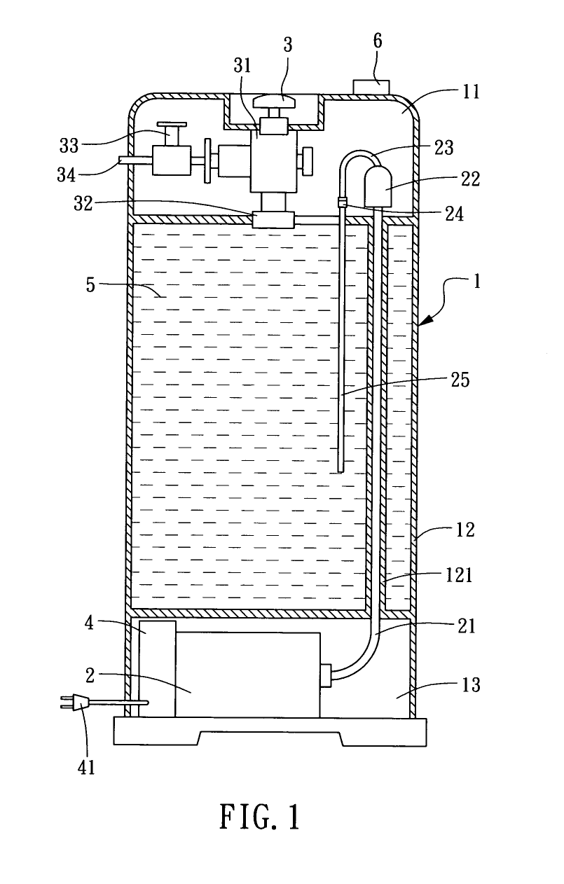

Referring to FIG. 1, FIG. 1 is a structure diagram of a low pressure liquid fuel gasification device of the present invention. As shown in FIG. 1, the low pressure liquid fuel gasification device includes a liquid fuel container 1. Three layers of containing space arranged vertically and including an upper containing space 11, a middle containing space 12 and a lower containing space 13 are defined in the container 1. The middle containing space 12 is disposed with a container pipe 121 communicating with the upper and lower containing space 11, 13. An air compressor 2 is disposed in the lower containing space 13. A pressure switch 22 is disposed in the upper containing space 11. An inner pipe 21 is disposed in the container pipe 121. One end of the inner pipe 21 is connected with the pressure switch 22 and the other end is connected with the air compressor 2. A check valve 24 is disposed in the upper containing space 11. A gas transmission pipe 23 is connected with the pressure switch 22 and the check valve 24. A gas input pipe 25 has one end connecting the check valve 24 and the other end extending into the bottom of the middle containing space 12. A gas pipe device includes a gas inlet 32 which has one opening end exposing to the middle containing space 12 and the other end connecting a relief valve 31. A rotation activation switch 3 is disposed at the relief valve 31. A pressure adjustment switch 33 is connected between a gas outlet and the relief valve 31. A low frequency vibration generating device 4 is disposed at the bottom of the middle containing space 12. A power activation switch 6 is disposed at a suitable position of the top of the container 1 and is linked with the pressure switch 22 and the air compressor 2.

When the power activation switch 6 is started, the air compressor 2 and the low frequency vibration generating device 4 are simultaneously activated. Low frequency vibration wave (between 50 Hz and 60 Hz) generated by the low frequency vibration device 4 enables compressed air generated by the air compressor 2 to have vibration energy. Meanwhile, the air compressor 2 transports the compressed air having vibration energy through the inner pipe 21 to the pressure switch 22. When the pressure of the compressed air is higher than the predetermined pressure configured by the pressure switch 22, the pressure switch 22 is activated to turn on whereby the compressed air having vibration energy can in turn flow through the gas transmission pipe 23, the check valve 24 and the gas input pipe 25 and then enter organic or inorganic oil liquid fuel 5 with a dry point between 50° C. and 90° C. When the compressed air having vibration energy contacts the molecule of the liquid fuel, the compressed air simultaneously vibrates the molecule of the liquid fuel and moves the molecule of the liquid fuel from the bottom of the middle containing space 12 to the top of the middle containing space 12. When a user turns on the rotation activation switch 3 to enable the relief valve 31 to turn on, the air gathered at the top of the middle containing space 12 and having the molecule of the fuel flows through the pressure adjustment switch 33 to the gas outlet 34 and then is ignited for use. Emission measure of the gas can be controlled through a user to adjust the pressure adjustment switch 33. The outputting pressure controlled by the pressure adjustment switch 33 is between 0.07 kg/cm² and 0.15 kg/cm². As shown in data, the outputting pressure of the household natural gas is 0.02 kg/cm², and the outputting pressure of the household liquefied petroleum gas is 0.078 kg/cm². Thus, the outputting pressure of the low pressure liquid fuel gasification device of the present invention between 0.07 kg/cm² and 0.15 kg/cm can widely fit to different burning devices such as a household gas stove and so on.

When a user turns off the rotation activation switch 3 to enable the pressure difference between the pressure inside the middle containing space 12 and the outputting pressure to reach the predetermined value of the pressure difference of the pressure switch 22, the pressure switch 22 links the power switch 6 to turn off. As an example of the embodiment of the present invention, the pressure difference may be configured between 0.2 kg/cm² and 0.3 kg/cm². The air compressor 2 is simultaneously turned off due to turnoff of the power switch 6 to enable the pressure in the middle containing space 12 to constantly maintain between 0.2 kg/cm² and 0.3 kg/cm². When a user wants to use and turn on the rotation activation switch 3, the pressure in the middle containing space 12 reduces. When the pressure difference between the opposite ends of the pressure switch 22 reaches the predetermined value of the pressure difference of the pressure switch 22, the pressure switch 22 links the power switch 6 to activate the air compressor 2 to enable the pressure in the middle containing space 12 to constantly maintain between 0.2 kg/cm² and 0.3 kg/cm², whereby the desired gas is obtained again from the gas outlet 34.

Comparing with the prior art, the low pressure liquid fuel gasification device of the present invention has the following advantages:

1. The low pressure liquid fuel gasification device of the present invention utilizes the low frequency vibration device to generate the vibration wave (between 50 Hz and 60 Hz). The contact between the vibration wave and the molecule of the organic or inorganic oil liquid fuel having the dry point between 50° C. and 90° C. enables the molecule of the liquid fuel to have vibration energy. The effect of the air vibration is good to fully gasify the molecule of the liquid fuel thereby greatly increasing burning effect.

2. The low pressure liquid fuel gasification device of the present invention utilizes the liquid fuel which is the organic or inorganic oil liquid fuel having the dry point between 50° C. and 90° C., such as mixed hexane and so on. The molecule state of this kind of fuel is stable at the normal temperature and under the normal pressure, and so the liquid fuel of the present invention is more secure than the common liquid fuel.

3. The low pressure liquid fuel gasification device of the present invention utilizes the liquid fuel which is the organic or inorganic oil liquid fuel having the dry point between 50° C. and 90° C., such as mixed hexane and so on. It is not easy to generate toxic gas and carbon monoxide during burning this kind of fuel and so it doesnot cause a user to poison, thereby greatly increasing security of use.

4. The low pressure liquid fuel gasification device of the present invention utilizes the pressure adjustment switch to control the outputting pressure between 0.07 kg/cm² and 0.15 kg/cm² and so widely fits to different types of burning devices, such as a common household gas stove and so on.

5. The low pressure liquid fuel gasification device of the present invention utilizes the power activation switch to link the pressure switch and the air compressor thereby properly automatically outputting gas or turn off power depending on if the rotation activation switch is turned on by a user.

6. The low pressure liquid fuel gasification device of the present invention is cooperatively used with the fuel which is liquid at the normal temperature and under the normal pressure. After the gasification device is activated, the pressure in the container is not more than 0.3 kg/cm², and the containing matter is saturated gas, which is not easy to cause gas explosion. Thus, the thickness of the device of the present invention is reduced and so the device of the present invention is lighter than a conventional high pressure filling container. The pressure in the conventional high pressure filling container is between 7 kg/cm² and 15 kg/cm². When the conventional high pressure filling container unintendedly leaks, it is easy to cause gas explosion, which results in great damage.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A low pressure liquid fuel gasification device comprising:
a container disposed with three layers of containing space in a vertical direction therein, the three layers of containing space including an upper containing space, a middle containing space and a lower containing space, the middle containing space being disposed with a container pipe communicating with the upper and lower containing space, the middle containing space being adapted to contain liquid fuel;
a gas outputting device including an air compressor disposed in the lower containing space; a pressure switch disposed in the upper containing space; an internal pipe disposed in the container pipe and having one end connecting the pressure switch and the other end connecting the air compressor; a check valve disposed in the upper containing space; a gas transmission pipe connecting with the pressure switch and the check valve; a gas inputting pipe having one end connecting the check valve and the other end extending into the bottom of the middle containing space;
a gas pipe device including a gas inlet which has an opening end exposing to the middle containing space and the other end connecting a relief valve; a rotation activation switch disposed at the relief valve; a gas outlet; a pressure adjustment switch connecting between the gas outlet and the relief valve;
a low frequency vibration generating device disposed at a proper position of the lower containing space for generating low frequency vibration wave;
a power activation switch linking the pressure switch and the air compressor;
wherein the air outputted from the air compressor of the low pressure liquid fuel gasification device is supplied with vibration energy by the low frequency vibration generating device, when the air with the vibration energy is transported to the liquid fuel in the middle containing space, the molecule of the liquid fuel is vibrated to generate molecule of gasified fuel, and the molecule of the gasified fuel is transported to the top of the middle containing space and received by the gas inlet of the gas pipe device.

2. The low pressure liquid fuel gasification device of claim 1, wherein the vibration frequency of the low frequency vibration wave generated by the low frequency vibration generating device is between 50 Hz and 60 Hz.

3. The low pressure liquid fuel gasification device of claim 1, wherein the liquid fuel is organic or inorganic oil liquid fuel with a dry point between 50° C. and 90° C.

4. The low pressure liquid fuel gasification device of claim 1, wherein the liquid fuel is mixed hexane.

5. The low pressure liquid fuel gasification device of claim 1, wherein the pressure controlled by the pressure switch is between 0.2 kg/cm² and 0.3 kg/cm².

6. The low pressure liquid fuel gasification device of claim 1, wherein the outputting pressure controlled by the pressure adjustment switch is between 0.07 kg/cm² and 0.15 kg/cm².

7. A low pressure liquid fuel gasification method comprising the following steps:
(a) utilizing a container to contain liquid fuel;
(b) utilizing an air compressor to compress air and utilizing a low frequency vibration generating device to generate low frequency vibration wave to enable the compressed air to have low frequency vibration energy;
(c) contacting the compressed air having the low frequency vibration energy with the liquid fuel to enable the liquid fuel to generate molecule of gasified fuel; and
(d) utilizing a pressure adjustment device and a gas leading device to control the outputting pressure of the molecule of the gasified fuel and transport the molecule of the gasified fuel to a burning device for burning.

8. The low pressure liquid fuel gasification method of claim 7, wherein the vibration frequency of the low frequency vibration wave generated by the low frequency vibration generating device is between 50 Hz and 60 Hz.

9. The low pressure liquid fuel gasification method of claim 7, wherein the liquid fuel is organic or inorganic oil liquid fuel with a dry point between 50° C. and 90° C.

10. The low pressure liquid fuel gasification method of claim 7, wherein the liquid fuel is mixed hexane.

11. The low pressure liquid fuel gasification method of claim 7, wherein the outputting pressure controlled by the pressure adjustment switch is between 0.07 kg/cm² and 0.15 kg/cm².
